(19) United States
(12) Patent Application Publication
(10) Pub. No.: US 2026/0341989 A1
(43) Pub. Date: Oct. 29, 2026

(54) COMPRESSED CABLE PLUG

(71) Applicant: Hewlett Packard Enterprise Development LP, Spring, TX (US)

(72) Inventor: Vincent Nguyen, Houston, TX (US)

(21) Appl. No.: 19/191,903

(22) Filed: Apr. 28, 2025

(51) Int. Cl. H01R 12/75; H01R 12/70

(52) U.S. Cl. CPC H01R 12/75; H01R 12/7023; H01R 12/7047

(57) ABSTRACT

One aspect of the instant disclosure provides a cable assembly. The cable assembly may include a cable and a cable plug comprising a paddle card. The paddle card may include a plurality of metal fingers electrically coupled to the cable. The cable assembly may further include a cable-mounting structure for mounting the cable plug onto a printed circuit board (PCB) comprising a plurality of contact pads, the metal fingers on the paddle card compressible into forming direct, single-sided longitudinal contact with the contact pads on the PCB.

### BACKGROUND

### Field

This disclosure relates to high-speed cable interconnect technologies. More specifically, this disclosure relates to an innovative cable interconnect design that enhances signal integrity, optimizes thermal management, and reduces manufacturing costs in computing systems.

### Related Art

The growing demands of modern data centers continue to drive high-density server architectures with multi-socket configurations. In these systems, processors (each typically occupying a dedicated socket) often exceed the physical capacity of a single printed circuit board (PCB). To expand capacity, modern servers often adopt a modular design that uses interchangeable, standardized components.

In a modular server system, compute, storage, and networking resources (e.g., CPUs, GPUs, or memory) are separated into modular units, allowing dynamic allocation via software. High-speed cable connections play an important role in the modular server system, providing seamless data flow, power delivery, and communication between hardware components. However, traditional cable connectors have their limitations due to cost and space constraint.

### BRIEF DESCRIPTION OF THE FIGURES

FIG. 1 illustrates examples of cable-to-board interconnect solutions, according to one aspect of the instant disclosure.

FIG. 2 provides a more detailed illustration of the components in an example PCB cable system, according to one aspect of the instant disclosure.

FIG. 3 illustrates an example printed circuit board (PCB) cable system with a mounting bracket, according to one aspect of the instant disclosure.

FIG. 4 illustrates examples of inter-board cable interconnects, according to one aspect of the instant disclosure.

FIG. 5 presents a flowchart illustrating an example process for connecting a cable to a printed circuit board (PCB), according to one aspect of the instant disclosure.

In the figures, like reference numerals refer to the same figure elements.

### DETAILED DESCRIPTION

Rising data rates in modern computing systems intensify signal integrity challenges when relying on PCB traces for interconnects between CPUs and between a CPU and I/O devices. To address these limitations, high-speed cables are used for both inter-board (between separate PCBs) and intra-board (within modular subsystems) connectivity. Compared with traditional PCB traces, high-speed cables offer better signal integrity, better scalability, and more development efficiency.

Although existing cable technologies like Mini Cool Edge Input Output (MCIO) can provide compact high-speed interconnect for modular systems, there remain footprint and cost challenges. The large number of MCIO connectors required on the motherboard or main logic board (MLB) of a system increases Bill of Materials (BOM) costs and assembly complexity. The connectors'physical profiles disrupt airflow and increase hotspot risks. Moreover, high-speed signals to and from the traditional cable connectors need to reach alternating current (AC)-coupling capacitors positioned on the PCB surface, requiring additional vias that introduce insertion loss and crosstalk. To overcome these challenges, the instant disclosure provides a low-cost, low-profile, via-optimized cable-to-board solution that balances density, thermal efficiency, and signal integrity in modular servers.

Conventional cable-to-board solutions rely on a two-component architecture having a male component (referred to as a cable plug) attached to the cable medium (e.g., coaxial wires or ribbon cables) and a female component (referred to as a socket or connector) mounted onto the surface of the PCB. PCB traces connect metal contacts within the socket to various components on the PCB. Therefore, electrical connections between the cable medium and the components can be established by inserting the cable plug into the socket/connector. To reduce the overall BOM and the height of the cable system, according to some aspects of the instant disclosure, the two-component architecture may be simplified to a one-component architecture by removing the female component. Using the one-component architecture, the male component (i.e., the cable plug) may be directly mounted onto the PCB surface.

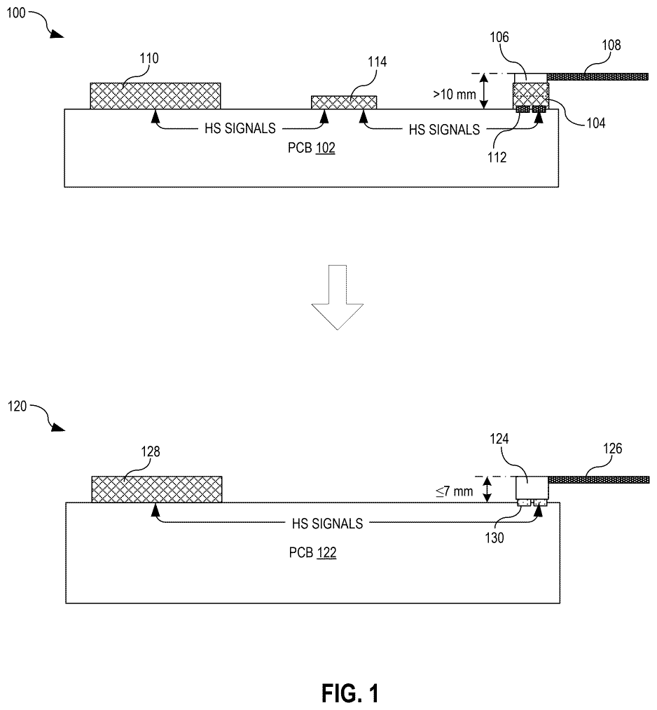

FIG. 1 illustrates examples of cable-to-board interconnect solutions, according to one aspect of the instant disclosure. The top portion of FIG. 1 shows a PCB cable system 100 using the conventional two-component architecture to achieve cable-to-board connections. PCB cable system 100 includes a PCB 102, a cable connector 104, and a cable plug 106, and a cable 108.

Cable connector 104 is mounted (e.g., by soldering) onto the top surface of PCB 102, providing electrical connectivity to various components on PCB 102, including processor 110. The electrical connections are achieved via contact pads (e.g., pad 112) and PCB traces (not shown in the drawing). Cable plug 106 is inserted into cable connector 104, enabling high-speed (HS) signals (e.g., Peripheral Component Interconnect Express (PCIe) signals, Ultra Path Interconnect (UPI) signals, or 10 Gigabit Media-Independent Interface (XGMII) signals) carried by cable 108 to reach the various components on PCB 102, including processor 110. In this example, cable connector 104 may also be connected to one or more AC-coupling capacitors (e.g., capacitor 114) located on the top surface of PCB 102, which serves to block direct current (DC) components from the HS signals, ensuring only the desired alternating current (AC) signal components are delivered to the PCB circuitry.

In this example, the combined height of the cable assembly, including cable connector 104 and cable plug 106, exceeds 10 mm. In server environments with 1U or 2U form factors, the presence of multiple protruding cable assemblies can significantly obstruct airflow, thereby reducing cooling efficiency. Additionally, since the AC-coupling capacitors are located on the top surface of PCB 102, all HS signals must be routed to this surface. Such routing requires additional vias (not shown), which can increase insertion loss and crosstalk, potentially degrading signal integrity.

The bottom portion of FIG. 1 shows a PCB cable system 120 that employs the one-component architecture for cable-to-board connections. PCB cable system 120 includes a PCB 122, a cable plug 124, and a cable 126. In this example, cable plug 124 may be directed mounted onto the top surface of PCB 122, enabling electrical connections between cable 126 and various components on PCB 122, such as a processor 128, without the need for a separate connector. Additionally, one or more AC-coupling capacitors may be integrated within cable plug 124. Consequently, HS signals (e.g., PCIe signals, UPI signals, or XGMII signals) carried by cable 126 may be routed to components on PCB 120 via contact pads (e.g., a pad 130) on the surface of PCB 122 and PCB traces located in various layers of the board. For simplicity of illustration, the PCB traces are not shown in the drawing.

By eliminating the need for a separate connector component, the cable assembly's total height is reduced from over 10 mm to 7 mm or less. Such a reduction minimizes airflow obstruction within the server chassis, enhancing cooling efficiency. Compared to the traditional two-component cable-to-board solution shown at the top, the one-component design shown at the bottom of FIG. 1 uses fewer components and provides better thermal performance. Moreover, moving the AC-coupling capacitors from the complex and noisy main PCB to an isolated environment of the cable plug may reduce insertion loss and crosstalk.

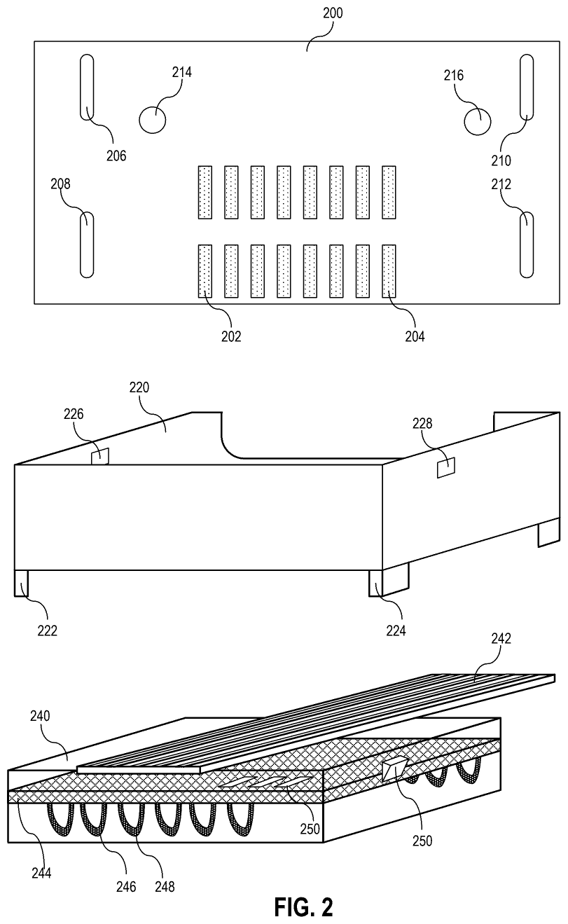

Modification to traditional cable plugs may be needed to facilitate effective electrical coupling between the cable plug and PCB traces. FIG. 2 provides a more detailed illustration of the components in an example PCB cable system, according to one aspect of the instant disclosure. Specifically, the top portion of FIG. 2 presents a top view of a PCB 200, the middle portion displays a perspective view of a cable-plug enclosure 220, and the bottom portion shows a perspective view of a cable plug 240.

The top surface of PCB 200 includes a plurality of contact pads, such as pads 202 and 204. These contact pads are typically composed of high-conductivity metal, including but not limited to gold, copper, aluminum, or any other materials known for excellent electrical performance. Unlike traditional solutions that use onboard connectors, where PCB contact pads are often coated with solder to facilitate connector attachment, the contact pads on PCB 200 are not solder-coated, as there is no connector to solder in this design. The quantity and spacing (pitch) of the contact pads are determined by the specific application requirements. In some examples, the contact pads may be arranged according to the SFA-TA-1016 standard, which specifies a pitch size of 0.6 mm.

PCB 200 may include a plurality of slots (e.g., slots 206, 208, 210, and 212). These slots are designed to accommodate snap latches from cable-plug enclosure 220, allowing secure mounting of the enclosure onto the top surface of PCB 200. The size and placement of each slot are matched to the corresponding snap latches on the enclosure for proper alignment and attachment. In this example, each slot is generally rectangular in shape.

PCB 200 may also include a number of additional holes (e.g., holes 214 and 216), which are designed to accommodate guide pins from the cable plug. These guide pins help ensure precise alignment so that the metal contacts within the cable plug are correctly positioned over the corresponding contact pads on PCB 200.

The primary function of the cable-plug enclosure 220 is to mount cable plug 240 on the surface of PCB 200, facilitating reliable electrical connections between the internal metal contacts of cable plug 240 and the contact pads on PCB 200. The shape and size of cable-plug enclosure 220 may correspond to the shape and size of cable plug 240 to allow cable plug 240 to fit snuggly inside cable-plug enclosure 220. In this example, cable-plug enclosure 220 has a rectangular prism design to accommodate the geometry of cable plug 240. Note that cable-plug enclosure 220 lacks a bottom floor, consisting solely of sidewalls to enable direct contact between its base and the surface of PCB 200.

The bottom edge of cable-plug enclosure 220 may be equipped with a number of snap latches (e.g., latches 222 and 224) aligned with corresponding slots on PCB 200. When these snap latches are inserted into the slots, cable-plug enclosure 220 can be securely mounted onto the surface of PCB 200.

The sidewalls of cable-plug enclosure 220 may include one or more openings (e.g., openings 226 and 228) used to receive snap latches on cable plug 240 in order to lock cable plug 240. These openings are intended to receive snap latches from cable plug 240, allowing cable plug 240 to be securely locked in place. The size and position of each opening are matched to those of a corresponding snap latch. In this example, each opening is generally rectangular in shape.

In the example shown in FIG. 2, cable plug 240 is coupled to a ribbon cable 242. Cable plug 240 may be an MCIO cable plug according to the SFA-TA-1016 standard, and cable 242 may be an MCIO cable. Cable plug 240 may include a paddle card (e.g., a small PCB) 244 having a plurality of metal fingers (e.g., fingers 246 and 248). The shape and positions of these metal fingers may match the shape and positions of the contact pads on the top surface of PCB 200. For simplicity of illustration, electrical connections between conducting wires in cable 242 and the metal fingers on paddle card 244 are not shown in FIG. 2. Standard cable termination techniques may be used to connect the conducting wires to the metal fingers. In one example, the conducting wires in the cable may be soldered to the metal fingers.

Cable plug 240 may include one or more snap latches (e.g., snap latch 250) on its sidewalls. When cable plug 240 is inserted into cable-plug encloser 220, these snap latches are engaged by being pushed into the corresponding openings on the sidewalls of enclosure 220, securely locking cable plug 240 in place.

According to some aspects, the metal fingers on paddle card 244 may include compressible spring-loaded contacts that are compressible or deformable. When cable plug 240 is inserted and locked into cable-plug enclosure 220, the spring-loaded contacts are compressed to be in direct contact, in the longitudinal direction (along the length of the metal fingers), with the contact pads on the top surface of PCB 200, thereby establishing electrical connections between conducting wires in cable 242 and the contact pads. The tension of the springs ensures sufficient and secure contact between the surfaces. Note that the manner in which the metal fingers establish contact with the contact pads is different from that of a conventional cable connector. In conventional cable connectors, the contact is established between a pin and a receptacle with the pin being inserted into the receptacle. In contrast, the present disclosure provides a flat, single-sided, longitudinal contact between the metal fingers and the contact pads, which can reduce material and manufacturing costs and increase contact density. Note that the fact that the longitudinal contact is single-sided makes the construction of the cable assembly more cost-effective.

Paddle card 244 may include a plurality of AC-coupling capacitors (e.g., capacitor 250) coupled to signal wires in cable 242. According to some aspects, paddle card 244 may include a multilayer PCB, and the AC-coupling capacitors may be embedded within the PCB's internal layers. By integrating the AC-coupling capacitors directly into cable plug 240, the need for additional vias to route signal traces to capacitors on the PCB surface is eliminated. This design reduces insertion loss and crosstalk for high-speed (HS) signals, resulting in improved signal integrity.

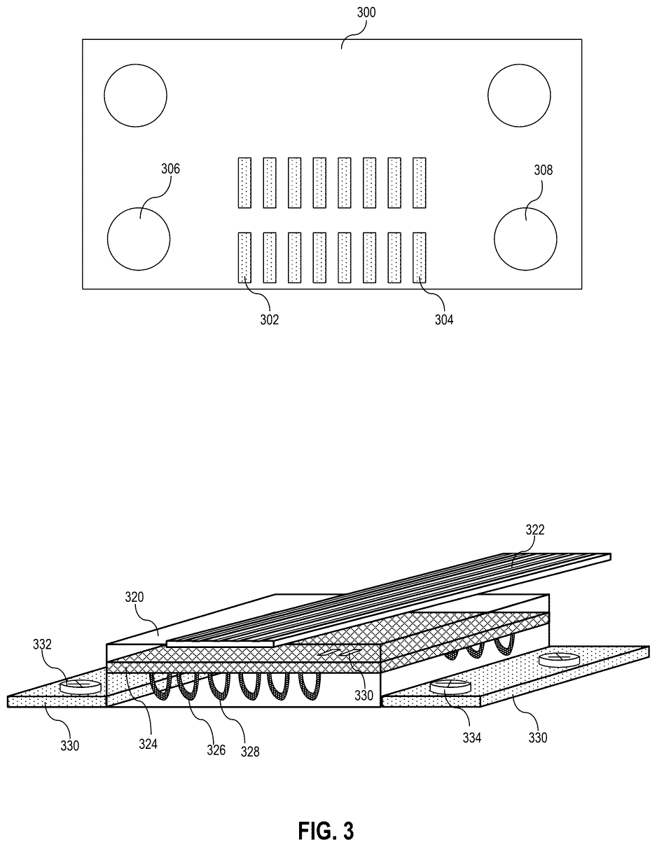

In addition to using a cable-plug enclosure, other mounting techniques may also be used to mount the cable plug onto the PCB. In some examples, the cable plug may include a mounting bracket used to mount the cable plug onto the surface of a PCB. FIG. 3 illustrates an example PCB cable system with a mounting bracket, according to one aspect of the instant disclosure.

The top portion of FIG. 3 shows the top view of a PCB 300, which includes a plurality of contact pads (e.g., contact pads 302 and 304) similar to the contact pads on the surface of PCB 200 shown in FIG. 2. In some examples, the contact pads may be arranged according to the SFA-TA-1016 standard, which defines a pitch size of 0.6 mm.

PCB 300 includes one or more screw holes (e.g., holes 306 and 308). These screw holes can be either through holes, which extend completely through the PCB, or blind holes, which do not penetrate the entire thickness of PCB 300. The through holes may be threaded or unthreaded, depending on the specific mounting requirements.

The bottom portion of FIG. 3 shows a cable plug 320 coupled to a ribbon cable 322. Cable plug 320 may be similar to cable plug 240 shown in FIG. 2 and includes a paddle card 324 having a plurality of compressible metal fingers (e.g., fingers 326 and 328) and integrated AC-coupling capacitors (e.g., capacitor 330). However, unlike cable plug 240, which has a substantially rectangular prism shape, cable plug 320 has a widened base 330 functioning as a mounting bracket.

Widened base 330 is equipped with a plurality of screw holes that align with the corresponding screw holes on PCB 300. This arrangement allows cable plug 320 to be securely mounted to the top surface of PCB 300 using screws, such as screws 332 and 334. In the example shown in FIG. 3, screws 332 and 334 may engage with screw holes 306 and 308, respectively, to firmly attach cable plug 320 to PCB 300.

The metal fingers on paddle card 324 may include spring contacts that are compressed when cable plug 320 is mounted onto PCB 300 using skews. Once compressed, these spring contacts make direct contact, in the longitudinal direction, with the contact pads on the top surface of PCB 300, thereby establishing reliable electrical connections between cable 322 and the PCB's contact pads.

The two mounting mechanisms illustrated in FIGS. 2 and 3 are provided as examples and are not intended to limit the scope of this disclosure. Alternative mounting methods may also be employed, provided they enable direct and reliable contact between the metal fingers of the cable plug and the contact pads on the PCB, without increasing the overall height of the cable assembly.

The connector-less, solder-less connection between the cable plugs and the PCB supports a flexible “pay-as-you-go” approach in modular server manufacturing. Since no connectors need to be soldered onto the board, the BOM cost for the main logic board (MLB) remains independent of the chosen I/O configuration. This allows a single printed circuit assembly (PCA) to serve as the MLB for servers with varying I/O requirements. A PCA is a PCB populated with electronic components. For example, the PCA of an MLB of a modular server may include multiple processors, each with its own I/O interface. During initial deployment, not all I/O interfaces may be utilized, leaving some unconnected. As additional I/O capacity is needed, additional cables can be mounted onto the MLB, enabling rapid and cost-effective system expansion without redesigning or reworking the board.

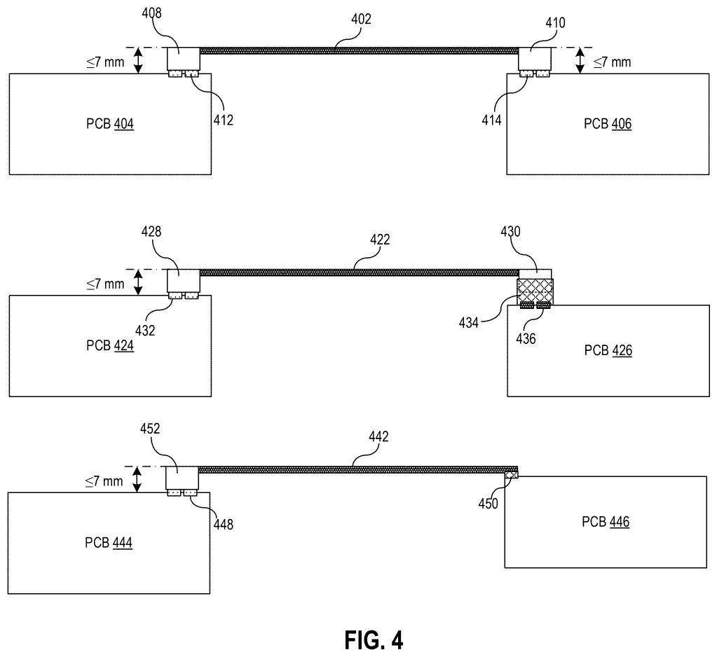

FIG. 4 illustrates examples of inter-board cable interconnects, according to one aspect of the instant disclosure. The top portion shows a scenario where a cable 402 is used to connect PCBs 404 and 406. The PCBs may include motherboards, mezzanine boards, riser boards, or any other board for mounting electronic components. Each end of cable 402 includes a cable plug for connecting to a PCB. In this scenario, each cable plug may include a mounting structure to allow it to establish connector-less and solder-less electrical connections with contact pads on the PCB. For example, cable plug 408 may be mounted on the surface of PCB 404 to establish electrical connections to contact pads on PCB 404 (e.g., contact pad 412). Similarly, cable plug 410 may be mounted on the surface of PCB 406 to establish electrical connections to contact pads on PCB 406 (e.g., contact pad 414).

The middle portion shows a scenario where a cable 422 is used to connect PCBs 424 and 426 via cable plugs 428 and 440, respectively. In this scenario, cable plug 428 includes a mounting structure to establish connector-less and solder-less electrical connections to contact pads (e.g., pad 442) on PCB 424. On the other hand, cable 440 is inserted into a connector 434, which is soldered onto contact pads (e.g., pad 436) on PCB 426. The two different plugs on cable 422 allow the cable to be connected to MLBs with and without soldered connectors.

The bottom portion shows a scenario where a cable 442 is used to connect PCBs 444 and 446. In this scenario, PCB 444 may be an MLB with a plurality of contact pads (e.g., pad 448) on its surface, and PCB 446 may be a riser board that include a high-speed I/O interface (e.g., PCIe, Open Compute Project (OCP), or any other industry standard high-speed I/O interface) with a plurality of contact fingers (e.g., finger 450). A riser board can increase the capacity of the motherboard to accept additional expansion boards. Cable 442 includes a cable plug 450 on one end to establish connector-less and solder-less electrical connections to the contact pads (e.g., pad 448) on PCB 444. The other end of cable 442 may be soldered directly to the contact fingers (finger 450) of the high-speed I/O interface on PCB 446. This design can improve the signal integrity of the high-speed signals between a motherboard and other expansion boards.

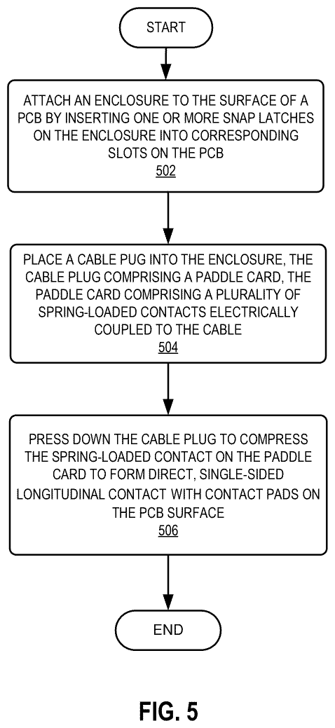

FIG. 5 presents a flowchart illustrating an example process for connecting a cable to a printed circuit board (PCB), according to one aspect of the instant disclosure. During operation, a cable installer may attach an enclosure to the surface of the PCB by inserting one or more snap latches on the enclosure into corresponding slots on the PCB (operation 502). The PCB may include top and bottom surfaces, and the enclosure may be attached to either surface. The enclosure may be made of durable material, such as metal, plastic, or any other appropriate material. The PCB may include one or more electrical components and an array of contact pads for connecting to a cable. The contact pads are not coated with a solder layer, as shown in the top portion of FIG. 2. The contact pads may be arranged according to the SFA-TA-1016 standard with a pitch size of 0.6 mm. The enclosure includes only sidewalls without a bottom floor. When the enclosure is mounted onto the surface of the PCB, it encloses the contact array.

The cable installer may place a cable plug into the enclosure, the cable plug comprising a paddle card, and the paddle card comprising a plurality of spring-loaded contacts electrically coupled to a cable (operation 504). The cable plug may be an MCIO cable plug according to the SFA-TA-1016 standard, and the cable may be an MCIO cable. The cable and cable plug are joined securely. The paddle card may include a small PCB with a number of integrated AC-coupling capacitors and PCB traces and/or contact pads. The spring-loaded contacts may be soldered onto the contact pads on the paddle card. Electrical coupling between the paddle card and metal wires in the cable may be achieved using standard cable termination techniques (e.g., soldering).

The cable installer may press down the cable plug to compress the spring-loaded contacts on the paddle card to form direct, single-sided longitudinal contact with contact pads on the PCB surface (operation 506). The enclosure may include a pair of openings on opposite sidewalls, as shown by the middle portion of FIG. 2. The cable plug may include a pair of snap latches, as shown by the bottom portion of FIG. 2. Pressing down the cable plug may cause the pair of snap latches on the cable plug to be inserted into the pair of openings on the sidewalls of the enclosure to lock the cable plug to the enclosure.

The installation of the cable requires no soldering or modification of the PCA, enabling the same PCA to support a variety of I/O configurations. Additionally, the innovative design of directly coupling the cable plug to the contact pads on the PCB surfaces can significantly reduce the risk of bent-pin issues that commonly occur during connector-to-connector mating in both factory assembly and field service operations.

Although the example process in FIG. 4 shows a specific order for performing certain operations, the process is not limited to such an order. Operations shown in succession in the flowchart may be performed in a different order and may be executed concurrently or with partial concurrence or combinations thereof.

In general, the disclosure provides a novel mechanism for connecting a cable to a PCA comprising various modules mounted on a PCB. Instead of using a two-piece configuration (i.e., a plug and a connector), a modified cable assembly may directly couple to contact pads on the PCB surface without using a connector. The modified cable assembly may include a cable plug and a cable-mounting structure for mounting the cable plug onto the PCB surface. The mounting structure may include an enclosure substantially surrounding the cable plug. The enclosure may include a number of snap latches for attaching the enclosure to the PCB and a locking mechanism for locking the cable plug to the enclosure. Alternatively, the cable-mounting structure may include a widened base (functioning as a mounting bracket) with one or more screw holes. The cable assembly may include a small PCB (referred to as a “paddle card”) with spring contacts to establish secure electrical connections with the contact pads on the MLB. The paddle card may also include integrated AC-coupling capacitors to improve signal integrity. Compared to conventional cable connectors, this new design reduces the cost and size of the cable assembly. The reduced size (more particularly the height) of the cable assembly improves air circulation within the server chassis.

One aspect of the instant disclosure provides a cable assembly. The cable assembly may include a cable and a cable plug comprising a paddle card. The paddle card may include a plurality of metal fingers electrically coupled to the cable. The cable assembly may further include a cable-mounting structure for mounting the cable plug onto a printed circuit board (PCB) comprising a plurality of contact pads, the metal fingers on the paddle card compressible into forming direct, single-sided longitudinal contact with the contact pads on the PCB.

According to a variation on this aspect, the cable mounting structure may include an enclosure to secure the cable plug.

According to a further variation, the enclosure may include a number of snap latches insertable into a number of corresponding slots on the PCB.

According to a further variation, the enclosure may further include a locking mechanism to lock the cable plug to the enclosure.

According to a further variation, the locking mechanism may include a number of openings on sidewalls of the enclosure to receive snap latches on the cable plug.

According to a variation on this aspect, the cable mounting structure may include a bracket with a number of screw holes to accommodate screws which secure the cable mounting structure to the PCB.

According to a variation on this aspect, the height of the cable assembly is equal to or less than 7 mm.

According to a variation on this aspect, the metal fingers on the paddle card may include spring-loaded contacts that are compressed onto the contact pads when the cable plug is mounted onto the PCB.

According to a variation on this aspect, the paddle card may include one or more alternating current (AC)-coupling capacitors.

According to a variation on this aspect, the cable plug may include a Mini Cool Edge Input Output (MCIO) cable plug, and the cable may include an MCIO ribbon cable.

One aspect of the instant disclosure provides a PCB cable system. The system may include a PCB comprising a plurality of contact pads located on the surface of the PCB, a cable, a paddle card comprising a plurality of metal fingers electrically coupled to the cable, a cable plug enclosing the paddle card, and a mounting structure to mount the cable plug onto the PCB. The metal fingers on the paddle card are compressible into forming direct, single-sided longitudinal contact with and electrically coupled to the contact pads on the PCB.

One aspect of the instant disclosure provides a method for connecting a cable to a PCB. The method may include attaching an enclosure to a surface of the PCB by inserting a number of snap latches on a bottom surface of the enclosure into a corresponding number of slots on the PCB; placing a cable plug into the enclosure, the cable plug comprising a paddle card, and the paddle card comprising a plurality of spring contacts electrically coupled to a cable; and pressing down the cable plug to compress the spring-loaded contacts on the paddle card to form direct, single-sided longitudinal contact with contact pads on the PCB surface.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatuses. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A cable assembly, comprising:
a cable;
a cable plug comprising a paddle card, the paddle card comprising a plurality of metal fingers electrically coupled to the cable; and
a cable-mounting structure for mounting the cable plug onto a printed circuit board (PCB) comprising a plurality of contact pads, the metal fingers on the paddle card compressible into forming direct, single-sided longitudinal contact with the contact pads on the PCB.

2. The cable assembly of claim 1, wherein the cable mounting structure comprises an enclosure to secure the cable plug.

3. The cable assembly of claim 2, wherein the enclosure comprises a number of snap latches insertable into a number of corresponding slots on the PCB.

4. The cable assembly of claim 2, wherein the enclosure further comprises a locking mechanism to lock the cable plug to the enclosure.

5. The cable assembly of claim 4, wherein the locking mechanism comprises a number of openings on sidewalls of the enclosure to receive snap latches on the cable plug.

6. The cable assembly of claim 1, wherein the cable mounting structure comprises a bracket with a number of screw holes to accommodate screws which secure the cable mounting structure to the PCB.

7. The cable assembly of claim 1, wherein a height of the cable assembly is equal to or less than 7 mm.

8. The cable assembly of claim 1, wherein the metal fingers on the paddle card comprise spring-loaded contacts that are compressed onto the contact pads when the cable plug is mounted onto the PCB.

9. The cable assembly of claim 1, wherein the paddle card comprises one or more alternating current (AC)-coupling capacitors.

10. The cable assembly of claim 1, where the cable plug comprises a Mini Cool Edge Input Output (MCIO) cable plug, and wherein the cable comprises an MCIO ribbon cable.

11. A PCB cable system, comprising:
a PCB comprising a plurality of contact pads located on a surface;
a cable;
a paddle card comprising a plurality of metal fingers electrically coupled to the cable;
a cable plug enclosing the paddle card; and
a mounting structure to mount the cable plug onto the PCB, the metal fingers on the paddle card compressible into forming direct, single-sided longitudinal contact with and electrically coupled to the contact pads on the PCB.

12. The PCB cable system of claim 11, wherein the mounting structure comprises an enclosure with sidewalls surrounding the cable plug.

13. The PCB cable system of claim 12, wherein the enclosure comprises a number of snap latches insertable into a number of corresponding slots on the PCB.

14. The PCB cable system of claim 12, wherein the sidewalls of the enclosure comprise a number of openings, and wherein the cable plug comprises a number of snap latches insertable into the openings on the sidewalls to lock the cable plug to the enclosure.

15. The PCB cable system of claim 11, wherein the mounting structure comprises a bracket with a number of screw holes to accommodate screws which secure the cable mounting structure to the PCB.

16. The PCB cable system of claim 11, wherein a height of the PCB cable system is equal to or less than 7 mm.

17. The PCB cable system of claim 11, wherein the metal fingers on the paddle card comprise spring-loaded contacts that are compressed onto the contact pads on the PCB when the cable plug is mounted onto the PCB.

18. The PCB cable system of claim 11, wherein the paddle card comprises one or more alternating current (AC)-coupling capacitors.

19. A method for connecting a cable to a PCB, the method comprising:
attaching an enclosure to a surface of the PCB by inserting a number of snap latches on a bottom surface of the enclosure into a corresponding number of slots on the PCB;
placing a cable plug into the enclosure, the cable plug comprising a paddle card, and the paddle card comprising a plurality of spring-loaded contacts electrically coupled to a cable; and
pressing down the cable plug to compress the spring-loaded contacts on the paddle card to form direct, single-sided longitudinal contact with contact pads on the PCB surface.

20. The method of claim 19, wherein the enclosure comprises a pair of openings on opposite sidewalls, wherein the cable plug comprises a pair of snap latches, and wherein pressing down the cable plug causes the pair of snap latches to be inserted into the pair of openings to lock the cable plug to the enclosure.
